(19) United States
(12) Patent Application Publication
(10) Pub. No.: US 2010/0005486 A1
(43) Pub. Date: Jan. 7, 2010

(54) APPARATUS AND METHOD FOR EMBEDDING COMMERCIALS

(75) Inventor: Eric Gross, Rochester, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/166,908

(22) Filed: Jul. 2, 2008

(51) Int. Cl. H04N 7/025

(52) U.S. Cl. 725/32

(57) ABSTRACT

An apparatus for embedding audio and/or video data in a program is provided. The apparatus includes a receiver operable to receive the program and a processor operable to determine if the program has a marker which indicates a portion of the program to be altered. The apparatus also includes a memory for storing the audio and/or video data. The processor alters the portion of the program using the audio and/or video data stored in the memory.

### BACKGROUND

The present disclosure is directed to the field of broadcast television, and more specifically to an apparatus and method for seamlessly embedding commercials into a broadcasted program.

Television advertisements or television commercials, hereinafter “commercials”, are spans of television programming used to deliver a message. Such commercials are a source of revenue for privately owned television networks such as ABC, NBC, CBS, etc. Television networks offer time slots in between and during regular television programming to different organizations in order to sell products, goods and services as well as getting out political messages. In return for the time slots, an organization pays a fee to the television network. For example, during the Superbowl, organizations pay millions of dollars for a thirty second time slot to get out their message.

With the advancement in technology fewer television viewers are watching commercials. By simply using a remote control, viewers can change channels to a different program when a commercial is aired. Alternatively, using digital video recorders (DVRs), which are provided by many cable and satellite television companies, a viewer records his/her favorite television programs to watch at a later time. When the viewer decides to watch the recorded television program, he/she simply skips the commercials that are recorded with the television program.

Recognizing that viewers are watching fewer commercials, many companies are using “product placement” in order to advertise their product. In product placement, a company pays to have its product featured prominently in a television show or movie. For instance, many James Bond movies use cars made by Aston Martin® or BMW® because the car makers paid to have their products prominently displayed.

Although product placement is considered an effective way of advertising products, it does have some drawbacks. In order to place a product into a television program, marketers have to collaborate with the program creators and writers so that appearance of the product occurs seamlessly. In addition, use of such product placement is beneficial for national brands. It can not be customized for smaller regions or from home to home.

### SUMMARY

According to the present disclosure, an apparatus and/or method is provided for embedding variable audio and/or video data in a program. The apparatus includes a receiver operable to receive the program and a processor operable to determine if the program has a marker. The marker indicates a portion of the program to be altered. The apparatus also includes a memory having said audio and/or video data where the processor alters the portion of the program using the audio and/or video data stored in the memory.

In an embodiment, the program comprises an audio portion and a video portion. If the portion of the program to be altered is the audio portion, the processor executes an algorithm to alter the video portion to match the altered audio portion.

In yet another embodiment illustrated herein a transmitter is provided to transmit the altered program to a user via cable or satellite.

In yet another embodiment illustrated herein, the apparatus receives the program via cable or satellite and outputs the altered program to a display unit operatively connected to the apparatus.

In yet another embodiment illustrated herein, the apparatus also includes a memory that profile information associated with a user. The profile information is used to determine the audio and/or video data that is used to alter the program. The profile information includes information about the user such as age, favorite stores, shopping habits, favorite movies, favorite television shows, favorite cuisines and other information specific to the user.

In yet another embodiment illustrated herein, a method is provided to embed a commercial in a broadcasted program. The method receives the broadcasted program and determines if the broadcasted program has a marker where the marker indicates a portion of the broadcasted program for embedding the commercial. The broadcasted program is then altered using the commercial.

In yet another embodiment illustrated herein, the broadcasted program includes audio and video data and said commercial includes audio and/or video data and if the audio data of the broadcasted program is altered using the audio data of the commercial, the video data of the broadcasted program is altered to match the altered audio data of the broadcasted program.

In yet another embodiment illustrated herein, the video data altered to match the altered audio data is video data associated with a character's mouth such that movement of the mouth matches the altered audio data.

### BRIEF DESCRIPTION OF THE DRAWINGS

FIG. 1 illustrates a system in accordance with the present disclosure.

FIG. 2 illustrates an apparatus in accordance with the present disclosure.

FIG. 3 illustrates an example of a process used to embed a commercial into a broadcasted program in accordance with the present disclosure.

FIG. 4 illustrates a flow chart of a method in accordance with the present disclosure.

### DETAILED DESCRIPTION

Embodiments will be described below while referencing to the accompanying figures. The accompanying figures are merely examples and are not intended to limit the scope of the invention.

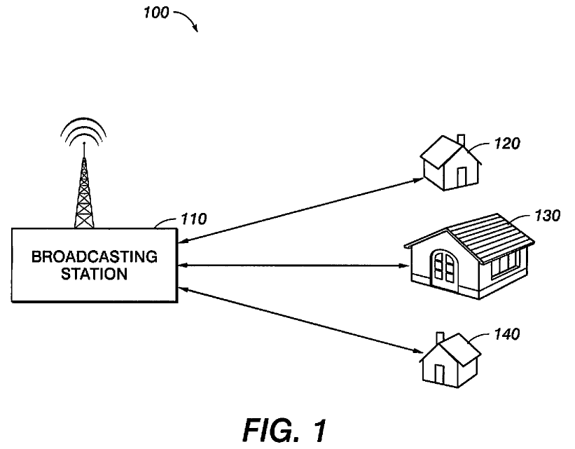

FIG. 1 illustrates a system 100 in accordance with the present disclosure. As shown in FIG. 1, there is a broadcasting station 110 that broadcasts programs to be viewed by a user. Broadcasting station 110 may broadcast programs via cable or satellite using a cable broadcasting system, satellite broadcasting system or the Internet. The programs are broadcasted to end users 120, 130 and 140. For instance, end user 120 may receive the program via a cable broadcast, end user 130 may receive a program via a satellite broadcast and end user 140 may receive the program via the Internet.

The end user may view the broadcasted program on a display unit capable of outputting audio and/or video data. For example, the display unit may be a television such as a cathode ray tube, plasma display panels, a liquid crystal displays, and rear projection televisions. The display unit may also be a computer monitor or any handheld device capable of outputting audio and/or video.

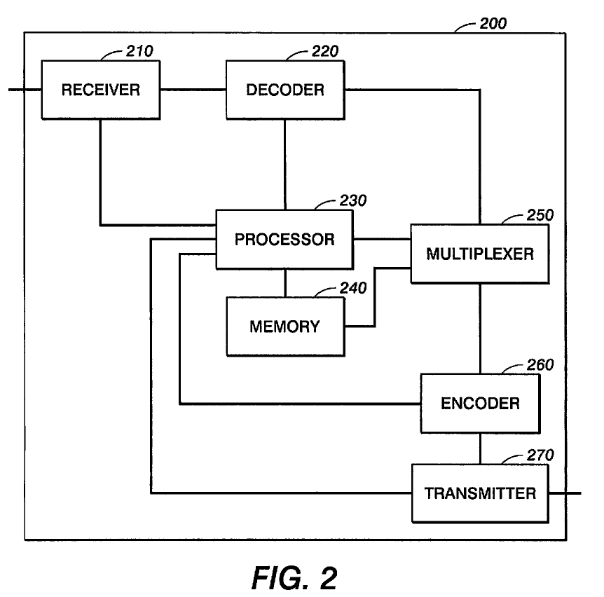

FIG. 2 illustrates an apparatus 200 used to embed commercials into a broadcasted program in accordance with the present disclosure. Apparatus 200 may be located at the broadcasting station 110 or at the end user. If the apparatus 200 is located at the end user, the apparatus 200 may be incorporated into a set top box or into the display unit.

Apparatus 200 includes a receiver 210 that receives the program. If the apparatus 200 is located at the broadcasting station 110, receiver 210 may receive the program from a server that stores the program or from another broadcasting station. If the apparatus 200 is located at the end user, receiver 210 receives the program from a broadcasting station via cable broadcasting, satellite broadcasting or the Internet. Receiver 210 outputs the received program to a decoder 220 that decodes the program and separates the audio and video data.

Commercial data is stored in memory 240. Commercial data includes audio and/or video data that is used to replace portions of the program received by receiver 210. Memory 240 also stores profile information for a user. If the apparatus 200 is located at the broadcasting station 110, memory 240 stores profile information for all the end users. If the apparatus 200 is located at the end user, for instance end user 120, then memory 240 stores profile information for the particular end user. The profile information includes information about the user such as age, favorite stores, favorite movies, favorite television shows, favorite cuisines and other information specific to the user.

Multiplexer 250 receives the audio and/or video data from decoder 220, audio and/or video data from memory 240 and, if applicable, receives video data from processor 230. The multiplexer 250 multiplexes the audio and/or video data and outputs the data to encoder 260. Encoder 260 encodes the audio/video data into a signal suitable for output via transmitter 270. For instance, if the apparatus 200 is at the broadcasting station 110, then encoder 260 encodes the signal into a format suitable for broadcasting via cable broadcasting, satellite broadcasting or the Internet. If the apparatus 200 is located at the end user, encoder 260 encodes the data so that it can be displayed on the display unit.

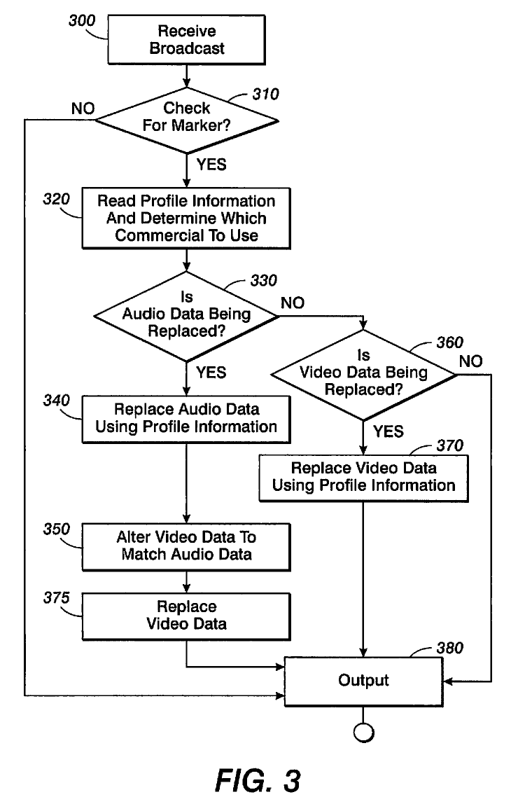

Processor 230 controls the operation of the apparatus 200 and embeds the commercial into the broadcasted program if necessary. FIG. 3 illustrates an example of a process used to embed a commercial into a broadcasted program. As shown in FIG. 3, in step 300 a broadcasted program is received. If a commercial is to be embedded into the broadcasted program, the broadcasted program may include a marker. The marker may be a flag, an interrupt, an n-bit signal, or any other method that indicates the portion of the broadcasted program that serves as a commercial opportunity and may have the nominal, or default message content replaced. Such a portion of the broadcasted program may be an audio portion, video portion or both.

In step 310, the processor determines if there is a marker in the broadcasted signal. If a marker does not exist, the broadcasted program is outputted in step 380. If a marker does exist, then the process proceeds to step 320 which reads the profile information stored in the memory. The profile information indicates the commercial content that should be used to replace, if so determined, the portion of the broadcasted program indicated by the user.

The process then proceeds to step 330 where a determination is made as to whether a portion of the audio data of the broadcasted program needs to be replaced. If the audio data needs to be replaced, the process proceeds to step 340 where the processor 230 controls the memory 240 to output the audio data indicated by the profile information to the multiplexer 250. Multiplexer 250 receives the audio data from memory 240 and overwrites the portion of the broadcasted program indicated by the marker with audio data from memory 240. In step 350, processor 230 receives the video data from decoder 220 and applies an algorithm to the received video data. The algorithm alters the video data so that when the audio portion that was overwritten is outputted, the lips of the character being displayed at the time matches the new audio data. The altered video data is then sent to the multiplexer 250 in step 375 and the video data from the broadcasted program is overwritten with the altered video data from processor 230.

In step 360, a determination is made as to whether the portion of the video data needs to be replaced. If a portion of the video data needs to be replaced, the processor proceeds to step 370 where the processor 230 controls the memory 240 to output the video data indicated by the profile information to the multiplexer 250. Multiplexer 250 receives the video data from memory 240 and overwrites the portion of the broadcasted program indicated by the marker with video data from memory 240.

In step 380, the audio and video data that have been replaced are encoded and outputted so that the altered program could be broadcasted or displayed on a display unit.

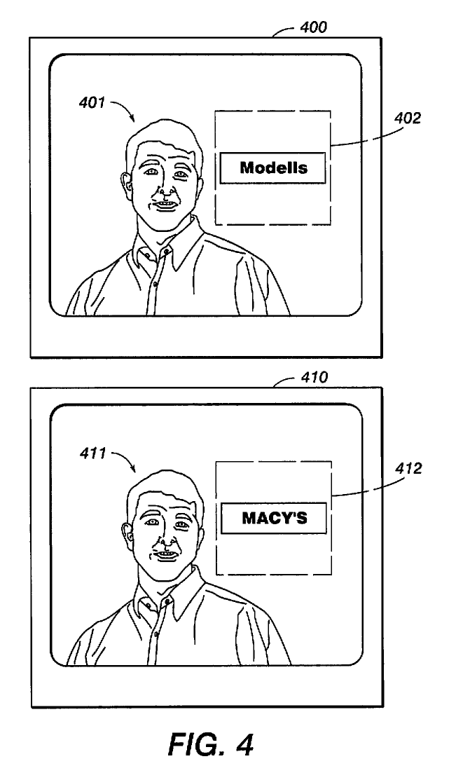

FIG. 4 illustrates two different displays that result from the above described process. As shown in FIG. 4, there is a display 400 which may be displayed at an end user's home and a display 410 which may be displayed at another end user's home. The two end users may be next door neighbors, live on different streets, in different cities, different states, or countries. Both display 400 and display 410 depict the same television program. However, the broadcasted program is altered so that it is customized for the individual user. For instance, the end user watching display 400 may be into sports. Therefore, the audio data would be altered so that when the character says the name of the store, the character would say Modell's®. In addition the video of the broadcasted program would be replaced so the sign 402 on the storefront shows Modell's® and lips 401 of the character would also be altered so that it seems as if he/she is saying Modell's®. On the other hand, the end user watching display 410 may be into clothing. Therefore, the audio data would be altered so that when the character says the name of the store, the character would say Macys®. In addition the video of the broadcasted program would be replaced so the sign 412 on the storefront shows Macys® and lips 411 of the character would also be altered so that it seems as if he/she is saying Macys®.

Accordingly, embedding commercials into broadcasted programming provides marketers another method to get their message out to the public without program interruption and on a customized basis. Aspects illustrated herein allow marketers to target specific homes that would be interested in their products without having to go through the rigors of conventional product placement. By embedding commercials into the programs, marketers can ensure that their message is not skipped due to channel changing or the use of DVRs.

It will be appreciated that variations of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. The claims can encompass embodiments in hardware, software, or combinations thereof.

1. An apparatus for embedding audio and/or video data in a program, said apparatus comprising:
receiver operable to receive said program;
processor operable to determine if said program has a marker, said marker indicating a portion of said program to be altered; and
memory having said audio and/or video data;
said processor altering said portion of said program using said audio and/or video data stored in said memory.

2. The apparatus according to claim 1, wherein said program comprises an audio portion and a video portion, wherein if said portion of said program to be altered is said audio portion, said processor executes an algorithm to alter said video portion to match said altered audio portion.

3. The apparatus according to claim 1, further comprising a transmitter operable to transmit the altered program to a user via cable or satellite.

4. The apparatus according to claim 1, wherein said apparatus receives said program via cable or satellite and outputs the altered program to a display unit operatively connected to said apparatus.

5. The apparatus according to claim 1, wherein said memory includes profile information associated with a user, said profile information is used to determine the audio and/or video data that is used to alter said program.

6. The apparatus according to claim 5, wherein the profile information may include but is not limited to information on age, favorite stores, favorite movies, favorite television shows, and favorite cuisines.

7. A method for embedding audio and/or video data in a program, said method comprising:
receiving said program;
determining if said program has a marker, said marker indicating a portion of said program to be altered; and
altering said portion of said program using said audio and/or video data stored in said memory.

8. The method according to claim 7, wherein said program comprises an audio portion and a video portion, wherein if said portion of said program to be altered is said audio portion, said video portion is altered to match said altered audio portion.

9. The method according to claim 7, further comprising transmitting the altered program to a user via cable or satellite.

10. The method according to claim 7, further comprising outputting the altered program to a display unit.

11. The method according to claim 7, wherein altering said program further comprises:
reading profile information associated with a user; and
determining the audio and/or video data that is used to alter said program.

12. The method according to claim 1, wherein the profile information may include but is not limited to information on age, favorite stores, favorite movies, favorite television shows, and favorite cuisines.

13. A method for embedding a commercial in a broadcasted program, said method comprising:
receiving said broadcasted program;
determining if said broadcasted program has a marker, said marker indicating a portion of said broadcasted program for embedding said commercial; and
altering said broadcasted program using said commercial.

14. The method according to claim 13, wherein said broadcasted program includes audio and video data and said commercial includes audio and/or video data and wherein if the audio data of said broadcasted program is altered using the audio data of said commercial, said video data of said broadcasted program is altered to match the altered audio data of said broadcasted program.

15. The method according to claim 14, wherein said video data altered to match the altered audio data is video data associated with a character's mouth such that movement of said mouth matches the altered audio data.

16. The method according to claim 13, further comprising transmitting the altered broadcasted program to a user via cable or satellite.

17. The method according to claim 13, further comprising outputting the altered broadcasted program to a display unit.

18. The method according to claim 13, wherein altering said program further comprises:
reading profile information associated with a user; and
determining the audio and/or video data that is used to alter said broadcasted program.

19. The method according to claim 18, wherein the profile information may include but is not limited to information on age, favorite stores, favorite movies, favorite television shows, and favorite cuisines.
